(19) United States
(12) Patent Application Publication
(10) Pub. No.: US 2011/0039624 A1
(43) Pub. Date: Feb. 17, 2011

(54) CYBER-PHYSICAL GAME

(76) Inventor: Miodrag POTKONJAK, Los Angeles, CA (US)

Correspondence Address: REN-SHENG INTERNATIONAL IP MANAGEMENT LTD.;GENE I. SU, 7F, No. 57, Sec. 2, DunHua South Road, TAIPEI, TW

(21) Appl. No.: 12/541,940

(22) Filed: Aug. 15, 2009

(51) Int. Cl. A63F 13/00

(52) U.S. Cl. 463/43

(57) ABSTRACT

Techniques are generally described related to model an actual sports game in a cyber-physical game. One example method may include one or more of receiving a first set of data collected from the actual sports game as the actual sports game is being played, generating an objective in the cyber-physical game based on the first set of data, receiving a second set of data as the cyber-physical game is being played, and evaluating the second set of data in view of the objective to generate a score and to determine whether to continue the cyber-physical game as the actual sports game is being played.

### BACKGROUND

Unless otherwise indicated herein, the approaches described in this section are not prior art to the claims in this application and are not admitted to be prior art by inclusion in this section.

A cyber-physical game is a game featuring a combination of and/or coordination between computational and physical elements in the game. A cyber-physical game may be an electronic game that involves interaction with a user interface to generate visual and/or audio feedback on a video and/or audio device. The electronic systems used to play cyber-physical games are known as platforms. Some examples of the platforms include personal computers, video game consoles, and handheld devices. The input device used to manipulate some cyber-physical games can be referred to as a game controller. For example, a game controller may feature one or more buttons and one or more joysticks.

One type of the cyber-physical game is a sports game that may involve physical and tactical challenges for a player. Some sports games are designed to model the athletic characteristics associated with the sports, including speed, strength, acceleration, accuracy, and so on.

### BRIEF DESCRIPTION OF THE DRAWINGS

The foregoing and other features of the present disclosure will become more fully apparent from the following description and appended claims, taken in conjunction with the accompanying drawings. These drawings depict only several embodiments in accordance with the disclosure and are, therefore, not to be considered limiting of its scope. The disclosure will be described with additional specificity and detail through use of the accompanying drawings.

In the drawings:

FIG. 1 is an example system configured to model an actual sports game in a cyber-physical game;

FIG. 2 is a flowchart of a method for scoring a shot hit by a cyber-physical game player;

FIG. 3 is a schematic drawing of a tennis court and a number of example landing locations of tennis shots;

FIG. 4 is a block diagram illustrating a computer program product for modeling an actual sports game in a computer; and

FIG. 5 is an example block diagram illustrating an example computing device that is arranged for modeling an actual sports game in a cyber-physical game, all arranged in accordance with at least some embodiments of the present disclosure.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the Figures, can be arranged, substituted, combined, and designed in a wide variety of different configurations, all of which are explicitly contemplated and make part of this disclosure.

This disclosure is drawn, inter alia, to methods, systems, and computer programs related to model an actual sports game in a cyber-physical game.

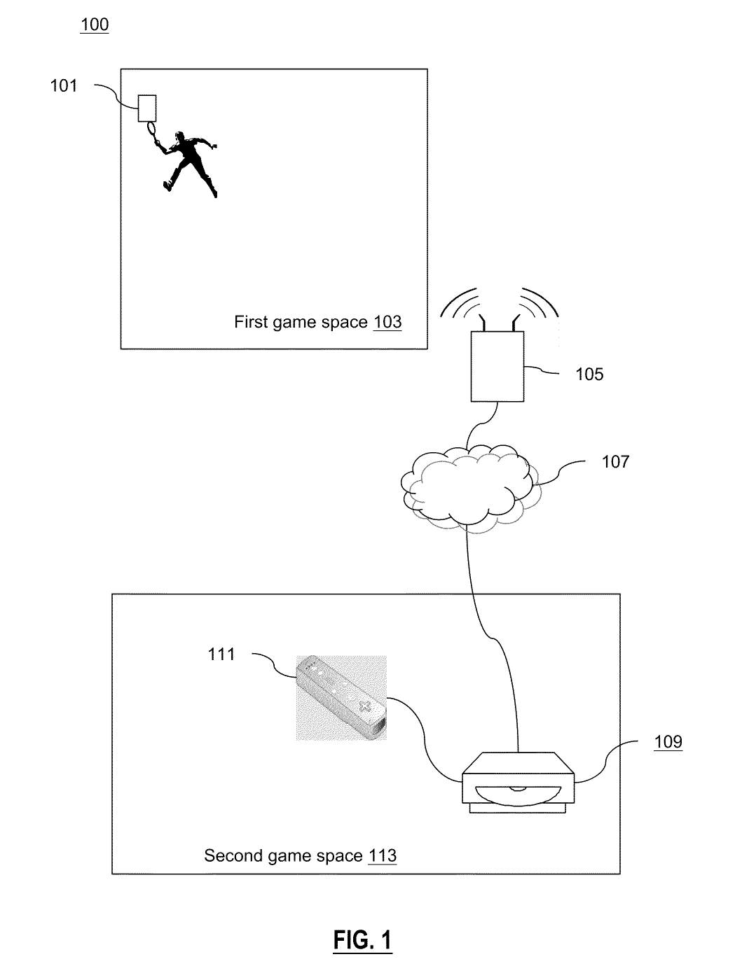

FIG. 1 is an example system 100 configured to model an actual sports game in a cyber-physical game, arranged according to at least some embodiments of the present disclosure. The system 100 may include a first sensor 101 in a first game space 103. The first sensor 101 may be configured to collect a first set of data associated with one or more events from the actual sports game as the actual sports game is being played in the first game space 103 (e.g., a human player playing on an actual sports field—not a computer simulation). The system 100 may further includes a network 107 through which the collected data may be transmitted to a computing device 109. The system 100 may also include a second sensor 111 in a second game space 113. The second sensor 111 may be configured to collect a second set of data associated with actions taken by a player of the cyber-physical game in the second game space 113 (e.g., a cyber-physical gamer playing on a “virtual” sports field supported by a computer). In the following discussions, to avoid any confusion, a player in the actual sports game may be referred to as an athlete, and a player of the cyber-physical game may be referred to as a cyber-physical game player.

Through the network 103, a base station 105 may be adapted to transmit the collected first set of data to the computing device 109. The connections among the base station 105, the network 103, and/or the computing device 109 may be either wired or wireless. Similarly, the connection between the computing device 109 and the second sensor 111 may also be either wired or wireless. The wired connection may include, without limitation, a cable connection or a Digital Subscriber Line (DSL). The wireless connection may be based on a wireless technology (e.g., Radio Frequency or RF based communications, Bluetooth communications, optical communications such as Infra-Red or IR, wireless local area network communications, etc.).

The computing device 109 may be configured to process the first set of data collected from the actual sports game and may generate one or more constraints and one or more objectives in the cyber-physical game. Some example constraints may include, without limitation, a set of rules of the actual sports game. Some example objectives may include, without limitation, hitting a winner in the cyber-physical game and/or making a correct prediction in the cyber-physical game. The computing device 109 may also be configured to process the second set of data to determine whether and/or how the one or more constraints and the one or more objectives may be met. Based on the determination, the computing device 109 may be configured to generate one or more scores for playing the cyber-physical game.

To illustrate, suppose the actual sports game is a tennis match, and the first game space 103 is the tennis court for the tennis match. Suppose also that the second game space 113 is a living room in which the cyber-physical game is being played. The first sensor 101 may be placed on a tennis racquet of an athlete in the tennis match to collect the first set of data associated one or more events of the match, and the second sensor 111 may be embedded in a game controller. An example event may include, without limitation, starting a match, hitting a serve, hitting a backhand, and others. The first set of data may include, without limitation, the environmental conditions on the tennis court (e.g., wind, temperature, humidity, daytime/nighttime, sunshine/clouds/rain, etc.), the movement of the athlete, and the acceleration of the tennis racquet. Alternatively, a number of the first sensors 101 may be placed on the tennis balls for the actual tennis match, so that the first set of data, such as, without limitation, the rotations of the tennis balls, the speed of the rotations, and the acceleration of the tennis balls may be captured. Alternatively, a number of the first sensors 101 may be placed around the perimeter of the first game space 103. In some implementations, the first sensors 101 may include audio and/or video recording devices to capture audio information and/or visual movement information relating to the tennis ball and the athlete. The sensor 101 may be wireless, and the collected information may be transmitted to the base station 105.

Based on the first set of data and physical laws and/or a predetermined set of mathematical equations and statistical relationships determined from historical data, the computing device 109 may, for example, be configured to estimate the flight of the tennis ball after the tennis ball is struck by the athlete in the actual tennis match. The estimated tennis ball flight may include any type of useful characteristics, including but not limited to scalar or vector quantities such as velocity, acceleration, angle of trajectory or ball location. The estimated tennis ball flights may then be utilized as one of the inputs to the cyber-physical game. Based on the processed first set of data (e.g., the estimated ball flight), the computing device 109 may be further configured to generate one or more objectives for the cyber-physical game. In some implementations, one example objective of the cyber-physical game may be for the cyber-physical game player to correctly predict what is going to happen in the actual sports game based on the one or more events that have already occurred. For example, after the athlete serves in the actual tennis match, the cyber-physical game player may be presented with the objective of properly guessing how many additional shots would be played between the athlete and his or her opponent. Such a type of a cyber-physical game may be associated with gambling. In some other implementations, after the athlete serves in the actual tennis match, the cyber-physical game player may see a modeled serve coming towards him according to the estimated ball flight and may be presented with the objective of properly returning the modeled serve in the cyber-physical game. How the aforementioned objectives are met may be adjusted based on a number of parameters, such as the skill level of the cyber-physical game player. Using the same tennis match example as an illustration, the computing device 109 may be configured to ease the criteria for meeting the objective by slowing down the modeled serve when the cyber-physical game player lacks experience and/or relaxing some other parameter or criteria in the cyber-physical game.

The second set of data captured by the second sensor 111 may be utilized to determine how and/or whether the one or more objectives of the cyber-physical game have been met. Some example data captured by the second sensor 111 may include, without limitation, the movements of feet and hands of the cyber-physical game player, the velocity, acceleration and/or position of the simulated tennis racquet (e.g., a game controller).

Using the example of returning the modeled serve in the cyber-physical game, in some implementations, the computing device 109 may be configured to consider three possible scenarios. The first scenario may refer to a clearly missed hit, meaning the return by the cyber-physical game player fails to cross the net or is out of bounds. The second scenario may refer to a clearly successful hit, meaning the return by the cyber-physical game player is statistically impossible for the athlete in the actual tennis match to keep in play. The third scenario may refer to other possible outcomes not covered by the first scenario and the second scenario. The computing device 109 may be configured to rely on historical data (e.g., the athlete's past actual tennis matches) to establish the likelihood of the athlete keeping a certain shot under certain circumstances in play. The computing device 109 may also establish the occurrence of any of the three scenarios based on factors, such as, without limitation, the modeled location or position at which the cyber-physical game player makes contact with the serve, the acceleration of the simulated tennis racquet, and the previously established likelihood data. After having determined whether and/or how the one or more objectives are met, the computing device 109 may be configured to determine the scoring for the cyber-physical game.

In some implementations, the computing device 109 may be configured to continue receiving additional sets of data associated with additional shots of the athlete in the actual sports game and continue the plays of the cyber-physical game. The system 100 may be configured to repeatedly operate as set forth above until a certain segment of the actual sports game is over (e.g., the athlete has won or lost the point in the actual tennis match). To illustrate using the tennis match example, after the cyber-physical game player returns the modeled serve, the athlete is likely to have played one or more shots against his opponent in the actual tennis match. To allow the cyber-physical game to continue as the actual tennis match is being played, in some implementations, the computing device 109 may ignore the one or more shots that have been played in the actual tennis match and process a newly captured set of data associated with a shot that the athlete is hitting (e.g., a forehand down the line to his or her opponent) and generate one or more constraints and one or more objectives for the cyber-physical game player to meet.

One scoring mechanism according to at least some embodiments of the present disclosure analyzes the second set of data, evaluates one or more possible scenarios, determines whether the outcome of the one or more possible scenarios is likely to meet the one or more objectives, and assigns points for meeting or failing to meet the one or more objectives. In some implementations, the point assignment may be determined by the difficulty of meeting the one or more objectives. For example, more points may be assigned for meeting a more difficult objective than meeting an easier objective.

In some other implementations, an example actual sports game may be a golf tournament. The first game space 103 may correspond to the golf course, at which the golf tournament is being held. The second game space 113 may correspond to an office, in which the cyber-physical game is being played. The first sensor 101 may be placed on a golf club to collect the first set of data associated one or more events of the golf tournament. An example event may include, without limitation, a golf stroke. The first set of data may include, without limitation, the environmental conditions on the golf course. Alternatively, a number of the first sensors 101 may be placed on the golf balls used in the golf tournament to capture information associated with the ball flight and positions of the golf balls.

After the golf ball hit by the athlete lands on the golf course, the cyber-physical game player may see a modeled ball flight of the golf shot and then may be presented with the objective of selecting an appropriate club and hit the golf ball from the landing location to as close to the green as possible. The second sensor 111 may be configured to collect the second set of data associated with the swing of the cyber-physical game player.

The second set of data may be utilized to estimate an outcome of the cyber-physical game player's swing. The computing device 109 may be configured to compare the distance and accuracy of the cyber-physical game player's shot with the athlete's shot in the golf tournament and provide a score based on the comparison result. The computing device 109 may also consider general golf rules (e.g., when a penalty stroke may be imposed, when a relief stroke is allowed, and others) to decide how to score the cyber-physical game player's shot.

In some other implementations, another example actual sports game may be car racing. The first game space 103 may correspond to a race track, and the second game space 113 may be a room in which the cyber-physical game is being played. The first sensor 101 may be placed on a car in the race to collect the first set of data associated one or more events of the race. An example event may include, without limitation, making a turn, changing a lane, and/or accelerating or decelerating the car. The first set of data may include, without limitation, the environmental and/or driving conditions on the race track. Alternatively, a number of the first sensors 101 may be placed on the actual driver of the racing car to capture information associated with actions taken by the driver. The captured information may include, without limitation, the movements of the hands and feet of the driver which may be associated with the event. For example, movements of the driver may indicate that the racing car is going to make a turn, change a lane, and/or accelerate or decelerate the car.

After the race starts, the cyber-physical game player may see a modeled race mimicking the actual race and may be presented with the objective of winning the race with the cyber-physical game player's simulated car. The second sensor 111 may be configured to collect the second set of data associated actions taken by the cyber-physical game player via, for example, a simulated steering wheel and a simulated pedal.

Based on both the first set of data and the second set of data, the computing device 109 may be configured to estimate the status of the simulated car in the cyber-physical game relative to the actual car in the car race and provide a score. In some implementations, the computing device 109 may be used in various fields (e.g., educational, sports training or medical rehabilitation).

In some other implementations, another example actual sports may be basketball. The first game space 103 may correspond to a basket court on which a basketball game is being played by two teams of athletes. The second game space 113 may correspond to a seat on a vehicle at which the cyber-physical game is being played. The first sensor 101 may be placed around the basket court to collect the first set of data associated one or more events of the basket ball game. The first sensor 101 may include a set of cameras. An example event may include, without limitation, dribbling the ball with the right hand, dribbling the ball with the left hand, passing the ball, blocking the ball, or shooting the ball. The first set of data may include, without limitation, the images of the athletes captured by the camera.

After the actual basket ball game starts, the cyber-physical game player may be presented with the objective of predicting and/or responding to the movements of the athlete and his team members in the actual basketball game. Based on the data collected in the historical games, a set of statistical relationships describing how the athlete and his team members may interact based on a particular action taken by the athlete may be obtained. With the statistical relationship, the first set of data, physical laws and/or a predetermined set of mathematical equations, the computing device 109 may present the objective to the cyber-physical game player shortly after the action taken by the athlete. In some implementations, the cyber-physical game player may be presented with the objective of defending the athlete and his team members in a fast-break situation. The second sensor 111 may be configured to collect the second set of data associated with actions taken by cyber-physical game player, for example, the hand and the feet movements of the cyber-physical game player.

Based on the second set of data, the computing device 109 may be configured to determine whether the cyber-physical game player achieves the presented objective (e.g., successfully stopping the fast-break) and score the actions taken by the cyber-physical game player accordingly.

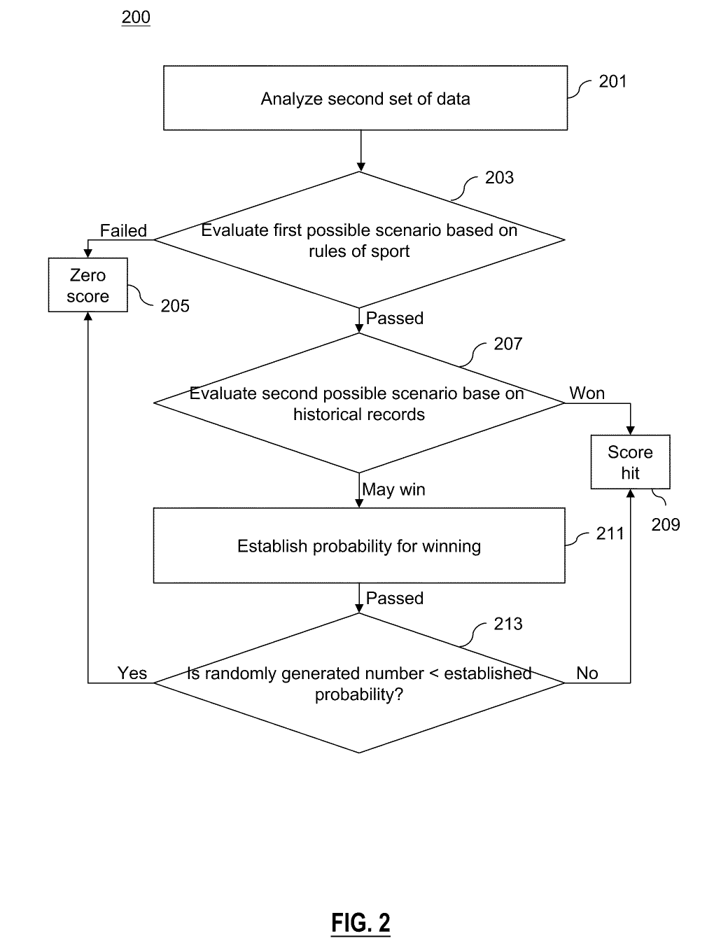

Continuing with the aforementioned tennis match example, FIG. 2 is a flowchart of a method 200 for scoring a shot hit by a cyber-physical game player, according to at least some embodiments of the present disclosure. For illustration, a hit that misses (e.g., failing to go over the net or out of bounds) may be assigned with a score of 0. A hit that is likely to win a point in the cyber-physical game may be assigned with a non-zero score. One objective of the cyber-physical game may be for the cyber-physical game player to win points from the athlete as the actual tennis match is being played.

Processing for method 200 may begin at block 201, where the method 200 may be arranged to analyze the second set of data, which may be associated with actions taken by the cyber-physical game player in the cyber-physical game. Continuing to block 203, the outcome of the analysis in block 201 may be evaluated against rules of the sport (e.g., tennis rules), and the result of the checking may affect scoring in block 205. Processing may continue at block 207, where a possible scenario of winning a point may be evaluated. Depending on the outcome of the evaluation at block 207, the method 200 may establish a probability number in block 211 for winning a point for the cyber-physical game player against the athlete or continues to block 209 when the outcome shows the return by the cyber-physical game player is statistically impossible for the athlete in the actual tennis match to keep in play. Block 211 may be followed by block 213, where the established probably number may be used to decide scoring.

In block 201, the second set of data associated with actions taken by the cyber-physical game player in the cyber-physical game may be analyzed, for example, to determine the ball flight and/or the possible landing location of the cyber-physical game player's hit. The determination may use any technically feasible solutions.

In block 203, the ball flight and/or the possible landing location of the cyber-physical game player's hit may be evaluated based on the rules of the sport to determine the first possible scenario of the cyber-physical game player's hit. Some example rules may include, without limitation, when a point is ruled to have been lost, dimensions of the tennis court, the height and the width of the net, and others. When the hit is determined to have failed (e.g., failing to cross the net or going out of bounds), the hit may be assigned a zero score in block 205. Otherwise, the method 200 may continue to block 207 when the hit was determined to have passed.

In block 207, historical records of the athlete in actual tennis matches may be considered to evaluate the second possible scenario of the cyber-physical game player's hit. To illustrate, the historical records of the athlete may include, without limitation, the highest moving speed of the athlete and the longest distance that the athlete successfully covered on a tennis court. For example, after the cyber-physical game player hits the shot, the shot may be determined to reach the possible landing location (e.g., position A) on the tennis court established in block 201 at time T1. Assuming the athlete is at position B on the tennis court at the time the cyber-physical game player's hits the shot, and based on the highest moving speed of the athlete from the historical records, the amount of time to cover the distance between position A and position B may be determined. If the athlete can only get to the point B long after T1, then the method 200 may proceed from block 207 to block 209, and the cyber-physical game player's hit is scored, because the cyber-physical game player would be a clear winner. Otherwise, the method 200 may proceed from block 207 to block 211.

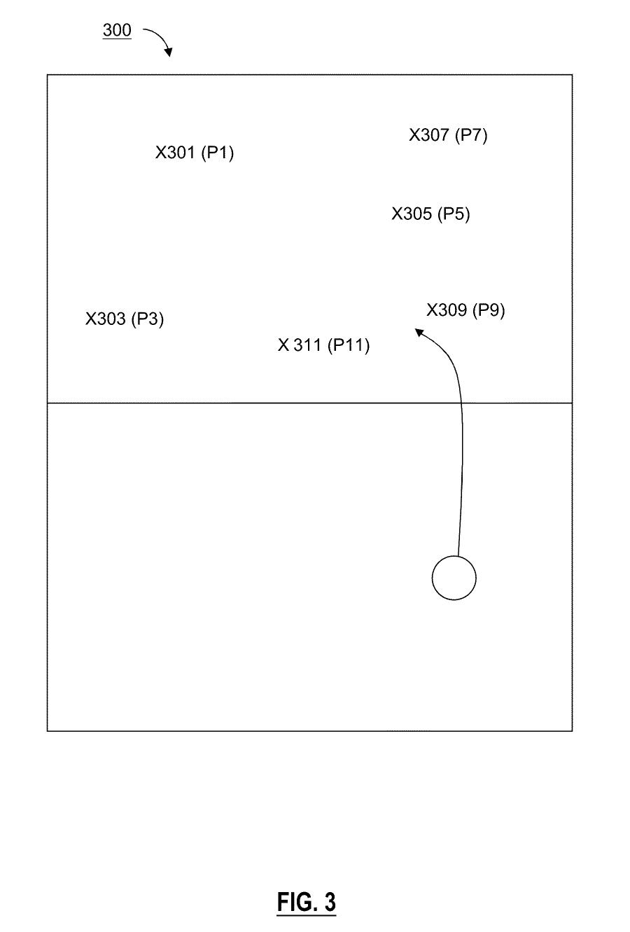

In block 211, a probability number for the cyber-physical game player to win a point against the athlete may be established. In some implementations, the historical records of the athlete and a statistical model may be utilized to establish the probability number. For example, the related historical records may include, without limitation, the locations on a tennis court where the athlete fails to return a shot. This can be further illustrated by FIG. 3 as will be discussed below.

FIG. 3 is a schematic drawing 300 of a tennis court and a number of example landing locations of tennis shots, according to at least some embodiments of the present disclosure. Based on prior tennis matches that the athlete played, a probability of the athlete failing to return a shot at each of the illustrated landing positions may be determined. For example, as illustrated in FIG. 3, at a position 301 there is a probability of P1 that the athlete may fail to return a shot. Suppose the possible landing position of the cyber-physical game player's hit is a position 311, which does not match any of the data captured in the historical records of the athlete. In some implementations, a technically feasible statistical technique may utilize other known positions (e.g., positions 301, 303, 305, 307, and 309) that are close to the position 311 and their associated probabilities (e.g., P1, P3, P5, P7, and P9) to establish the probability of the athlete failing to return a shot at the position 311 (e.g., P11). Some example statistical techniques may include, without limitation, processes and methods for kernel estimation, boosting, shape regressions, smoothing, monotonic regressions, and convex regressions. Any statistical models established by the statistical technique may be combined using some techniques which may include, without limitation, maximum likelihood estimation and inferential statistics. In some other implementations, the heuristic technique may be used to facilitate the modeling. For example, if the historical records of the athlete indicate that the athlete rarely goes to the position 305, then the statistical technique may be applied only to the positions 301, 303, 307, and 309 to more efficient processing. In other examples, the historical records of the athletes frequency of moving to the positions may be used as a weighting factor in the statistical technique, e.g., more frequently visited positions are weighted more heavily than infrequently visited positions.

Referring again to FIG. 2, in block 213, a randomly generated number may be compared with the established probably number (e.g., P11) to determine whether to score the hit of the cyber-physical game player. In some implementations, the randomly generated number ranges between 0 and 1. If the number is equal to or greater than P11, then this may indicate that the athlete fails to return the cyber-physical game player's hit, and the method 200 proceed from block 213 to block 209 to score the hit. On the other hand, if the number is less than P11, then this may indicate that the athlete returns the ball, and processing may continue from block 213 to block 205, where the hit of the computer cyber-physical player may not be scored.

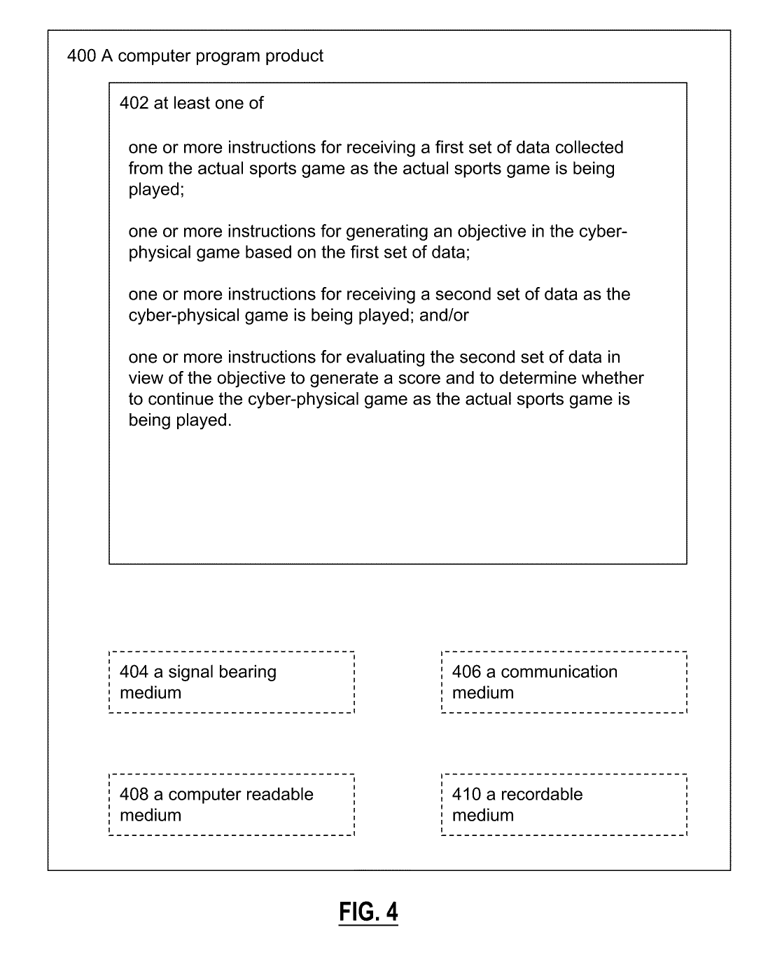

FIG. 4 is a block diagram illustrating a computer program product 400 for modeling an actual sports game in a computer in accordance with at least some embodiments of the present disclosure. Computer program product 400 may include one or more sets of executable instructions 402 for executing the method described above and illustrated in FIG. 2. Computer program product 400 may be transmitted in a signal bearing medium 404 or another similar communication medium 406. Computer program product 400 may also be recorded in a computer readable medium 408 or another similar recordable medium 410.

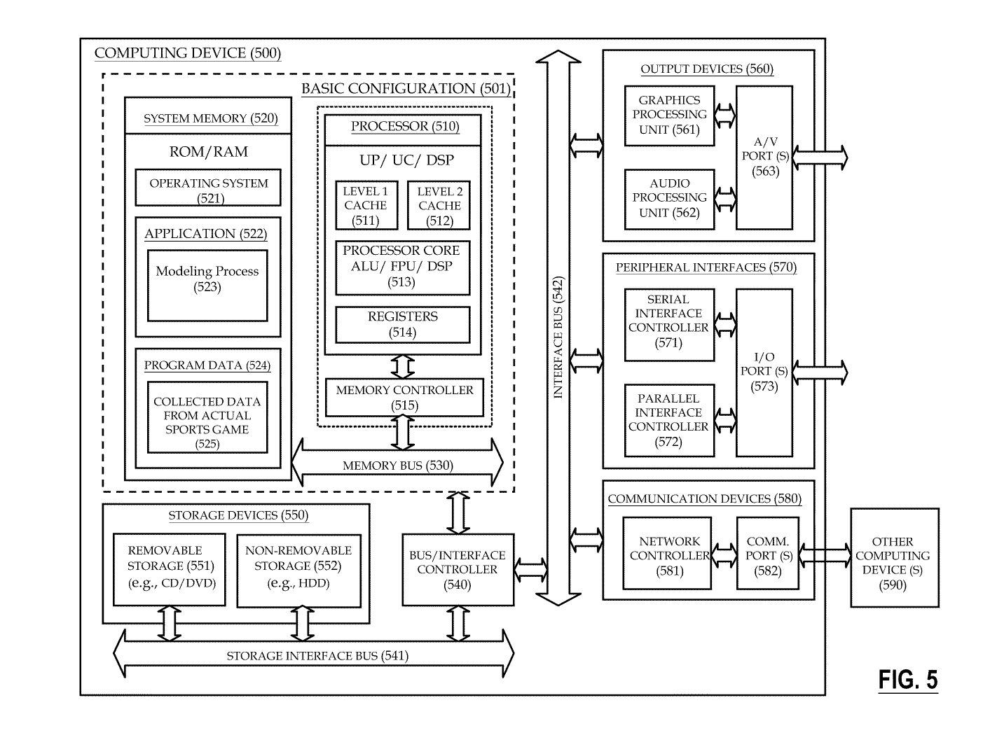

FIG. 5 is an example block diagram illustrating an example computing device 500 that is arranged for modeling an actual sports game in a cyber-physical game in accordance with some embodiments of the present disclosure. In a very basic configuration 501 (shown in dashed lines), computing device 500 may typically include one or more processors 510 and system memory 520. A memory bus 530 may be used for communicating between the processor 510 and the system memory 520.

Depending on the desired configuration, processor 510 may be of any type including but not limited to a microprocessor (μP), a microcontroller (μC), a digital signal processor (DSP), or any combination thereof. Processor 510 may include one more levels of caching, such as a level one cache 511 and a level two cache 512, a processor core 513, and registers 514. An example processor core 513 may include an arithmetic logic unit (ALU), a floating point unit (FPU), a digital signal processing core (DSP Core), or any combination thereof. An example memory controller 515 may also be used with the processor 510, or in some implementations the memory controller 515 may be an internal part of the processor 510.

Depending on the desired configuration, the system memory 520 may be of any type including but not limited to volatile memory (such as RAM), non-volatile memory (such as ROM, flash memory, etc.) or any combination thereof. System memory 520 may include an operating system 521, one or more applications 522, and program data 524. Application 522 may include a modeling process 523, which may be arranged to model an actual sports game in a cyber-physical game. Program Data 524 may include sets of data collected from an actual sports game as set forth above. In some embodiments, application 522 may be arranged to operate with program data 524 on an operating system 521 such that the collected sets of data from the actual sports game may be evaluated in accordance with the various techniques described herein.

Computing device 500 may have additional features or functionality, and additional interfaces to facilitate communications between the basic configuration 501 and any required devices and interfaces. For example, a bus/interface controller 540 may be used to facilitate communications between the basic configuration 501 and one or more data storage devices 550 via a storage interface bus 541. The data storage devices 550 may be removable storage devices 551, non-removable storage devices 552, or a combination thereof. Examples of removable storage and non-removable storage devices include magnetic disk devices such as flexible disk drives and hard-disk drives (HDD), optical disk drives such as compact disk (CD) drives or digital versatile disk (DVD) drives, solid state drives (SSD), and tape drives to name a few. Example computer storage media may include volatile and nonvolatile, removable and non-removable media implemented in any method or technology for storage of information, such as computer readable instructions, data structures, program modules, or other data.

System memory 520, removable storage 551 and non-removable storage 552 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which may be used to store the desired information and which may be accessed by computing device 500. Any such computer storage media may be part of device 500.

Computing device 500 may also include an interface bus 542 for facilitating communication from various interface devices (e.g., output interfaces, peripheral interfaces, and communication interfaces) to the basic configuration 501 via the bus/interface controller 540. Example output devices 560 include a graphics processing unit 561 and an audio processing unit 562, which may be configured to communicate to various external devices such as a display or speakers via one or more AN ports 563. Example peripheral interfaces 570 include a serial interface controller 571 or a parallel interface controller 572, which may be configured to communicate with external devices such as input devices (e.g., keyboard, mouse, pen, voice input device, touch input device, etc.) or other peripheral devices (e.g., printer, scanner, etc.) via one or more I/O ports 573. An example communication device 580 includes a network controller 581, which may be arranged to facilitate communications with one or more other computing devices 590 over a network communication link and/or channel via one or more communication ports 582.

The network communication link and/or channel may be one example of a communication media. Communication media may typically be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), microwave, infrared (IR) and other wireless media. The term computer readable media as used herein may include both storage media and communication media.

Computing device 500 may be implemented as a portion of a small-form factor portable (or mobile) electronic device such as a cell phone, a personal data assistant (PDA), a personal media player device, a wireless web-watch device, a personal headset device, an application specific device, or a hybrid device that include any of the above functions. Computing device 500 may also be implemented as a personal computer including both laptop computer and non-laptop computer configurations.

There is little distinction left between hardware and software implementations of aspects of systems; the use of hardware or software is generally (but not always, in that in certain contexts the choice between hardware and software can become significant) a design choice representing cost vs. efficiency tradeoffs. There are various vehicles by which processes and/or systems and/or other technologies described herein can be effected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; if flexibility is paramount, the implementer may opt for a mainly software implementation; or, yet again alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a Compact Disc (CD), a Digital Video Disk (DVD), a digital tape, a computer memory, etc.; and a transmission type medium such as a digital and/or an analog communication medium (e.g., a fiber optic cable, a waveguide, a wired communications link and/or channel, a wireless communication link and/or channel, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein can be integrated into a data processing system via a reasonable amount of experimentation. Those having skill in the art will recognize that a typical data processing system generally includes one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity; control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

I claim:

1. A method for modeling an actual sports game in a cyber-physical game, the method comprising:
receiving a first set of data collected from the actual sports game as the actual sports game is being played;
generating an objective in the cyber-physical game based on the first set of data;
receiving a second set of data as the cyber-physical game is being played; and
evaluating the second set of data in view of the objective to generate a score and to determine whether to continue the cyber-physical game as the actual sports game is being played.

2. The method of claim 1, wherein receiving a first set of data takes place prior to receiving a second set of data.

3. The method of claim 2, wherein evaluating the second set of data comprises receiving a third set of data from the actual sports game.

4. The method of claim 1, wherein the first set of data is associated with one or more events in the actual sports game.

5. The method of claim 1, further comprising retrieving a set of historical data relating to an athlete in the actual sports game to determine a probability for the athlete to successfully handle a situation generated by the cyber-physical game based on the second set of data.

6. The method of claim 5, further comprising applying a statistical technique on the set of historical data to establish a model.

7. The method of claim 5, further comprising randomly generating a number to compare against the determined probability.

8. A computing device for modeling an actual sports game in a cyber-physical game, the computing device comprising:
a memory; and
a processing unit arranged to interface with the memory, wherein the processing unit is configured to:
receive a first set of data collected from the actual sports game as the actual sports game is being played;
generate an objective in the cyber-physical game based on the first set of data;
receive a second set of data as the cyber-physical game is being played; and
evaluate the second set of data in view of the objective to generate a score and to determine whether to continue the cyber-physical game as the actual sports game is being played.

9. The computing device of claim 8, wherein the processing unit is further configured to receive the first set of data prior to the second set of data.

10. The computing device of claim 8, wherein the first set of data is associated one or more events in the actual sports game.

11. The computing device of claim 8, wherein the processing unit is further configured to retrieve a set of historical data relating to an athlete in the actual sports game to determine a probability for the athlete to handle a situation generated by the cyber-physical game based on the second set of data.

12. The computing device of claim 11, wherein the processing unit is further configured to apply one or more statistical techniques on the set of historical data to establish a model.

13. The computing device of claim 11, wherein the processing unit is further configured to randomly generate a number to compare against the determined probability.

14. The computing device of claim 11, wherein the processing unit is further configured to apply one or more heuristic and statistical techniques to the set of historical data.

15. The computing device of claim 8, wherein the computing device is configured to execute the cyber-physical game to be used in educational, sports training, or medical rehabilitation purposes.

16. A computer-readable medium containing a sequence of instructions for modeling an actual sports game in a cyber-physical game, which when executed by a computing device, causes the computing device to:
receive a first set of data collected from the actual sports game as the actual sports game is being played;
generate an objective in the cyber-physical game based on the first set of data;
receive a second set of data as the cyber-physical game is being played; and
evaluate the second set of data in view of the objective to generate a score and to determine whether to continue the cyber-physical game as the actual sports game is being played.

17. The computer-readable medium of claim 16, further including a sequence of instructions, which when executed by the computing device, causes the computing device to receive the first set of data prior to receiving the second set of data.

18. The computer-readable medium of claim 17, further including a sequence of instructions, which when executed by the computing device, causes the computing device to receive a third set of data from the actual sports game.

19. The computer-readable medium of claim 16, wherein the first set of data is associated with one or more events in the actual sports game.

20. The computer-readable medium of claim 19, further including a sequence of instructions, which when executed by the computing device, causes the computing device to retrieve a set of historical data relating to an athlete in the actual sports game to determine a probability for the athlete to handle a situation generated by the cyber-physical game based on the second set of data.

21. The computer-readable medium of claim 20, further including a sequence of instructions, which when executed by the computing device, causes the computing device to randomly generate a number to compare against the determined probability.
